(19) United States
(12) Patent Application Publication
(10) Pub. No.: US 2009/0058357 A1
(43) Pub. Date: Mar. 5, 2009

(54) Battery Charging Unit

(76) Inventors: John Victor Saker, Essex (GB); Peter Alan Clayton, Kent (GB)

Correspondence Address: Shaper Iler;Sue Z. Shaper, 1800 West Loop South Suite 1450, Houston, TX, 77027, US

(21) Appl. No.: 11/918,575

(22) PCT Filed: Apr. 19, 2006
(86) PCT No.: PCT/GB2006/001410

§ 371 Date: Apr. 7, 2008

(30) Foreign Application Priority Data
Apr. 20, 2005 (GB) 0507961.1

(51) Int. Cl. H02J 7/00

(52) U.S. Cl. 320/107

(57) ABSTRACT

An arrangement for charging a battery provided on a trolley, for example a battery used to run a display units, alarms or calls for assistance provided on shopping or supermarket trolleys, the arrangement comprising a charging station having guide rail with a channel, at least two contacts such as brush strips being disposed within the channel, the contacts being arranged to electrically interact with at least two contact areas provided on a part of the trolley, such as a handle, which is insertable into the channel.

This application is a US National Stage of PCT/GB2006/001410, filed Apr. 19, 2006, claiming priority to GB application 0507961.1 filed Apr. 20, 2005.

### FIELD OF THE INVENTION

This invention relates to battery charging, and specifically to charging stations for battery operated equipment provided on a trolley.

### BACKGROUND OF THE INVENTION

One method of charging a battery for use in battery operated equipment provided on a trolley is to remove the battery from the trolley and place in a charger. However, this method increases the likelihood of damage to the battery as it is removed from the trolley, and increases wear of the attachment means to the trolley. It is also not desirable from a security aspect to allow the battery to be removed from the trolley.

Another method of charging such batteries is by means of a central charging unit provided with a number of umbilical cords to be attached to each trolley/battery. However, with this method it cannot be ensured that each battery has sufficient charging time before it is removed, as the trolleys can be attached and disengaged from the umbilical cords in any order.

It is known from U.S. Pat. No. 5,773,954 to provide closed-ended guideways on either side of a charging bay. However, this arrangement would require all trolleys to be the same width, which is not the case the all supermarkets. Also, the last trolley to enter the charging bay would be the first to be removed, and therefore could have a lesser charge than the other trolleys. Further, the first trolleys to have entered the charging bay, i.e. those which have been charging for the longest amount of time, may have been damaged by overcharging.

### SUMMARY OF THE INVENTION

Accordingly the present invention provides an arrangement for charging a battery provided on a trolley comprising a channel with linear contacts and on a part of the trolley contacts arranged to interact electrically with the linear contacts, characterised in that the channel is open at both ends and at least two of the trolley contacts are each connected to different poles of the battery. The invention is useful in that a charging station may be provided for battery operated equipment such as display units, alarms or calls for assistance provided on shopping or supermarket trolleys. Display units on shopping trolleys are known, e.g. WO98/55954 (Texion Corporation).

### BRIEF DESCRIPTION OF THE DRAWINGS

Reference will now be made to embodiments of the invention by way of example to the accompanying drawings.

FIG. 1 is a perspective view of an arrangement for charging batteries on shopping trolleys in accordance with the present invention.

FIGS 1a and 1b show an alternative guide rail for the arrangement of FIG. 1.

FIG. 2 is a longitudinal cross section of a trolley handle and guide rail for the arrangement of FIG. 1.

FIG. 3 is an end view of a trolley handle as shown in FIG. 2.

FIG. 4 is a longitudinal cross section of an alternative embodiment of a guide rail and trolley handle in accordance with the present invention.

FIG. 5 is a schematic representation of a charging circuit suitable for use with the arrangement of FIG. 1.

FIG. 6 shows an alternative embodiment of the arrangement of FIG. 1.

### DETAILED DESCRIPTION OF PREFERRED EMBODIMENTS

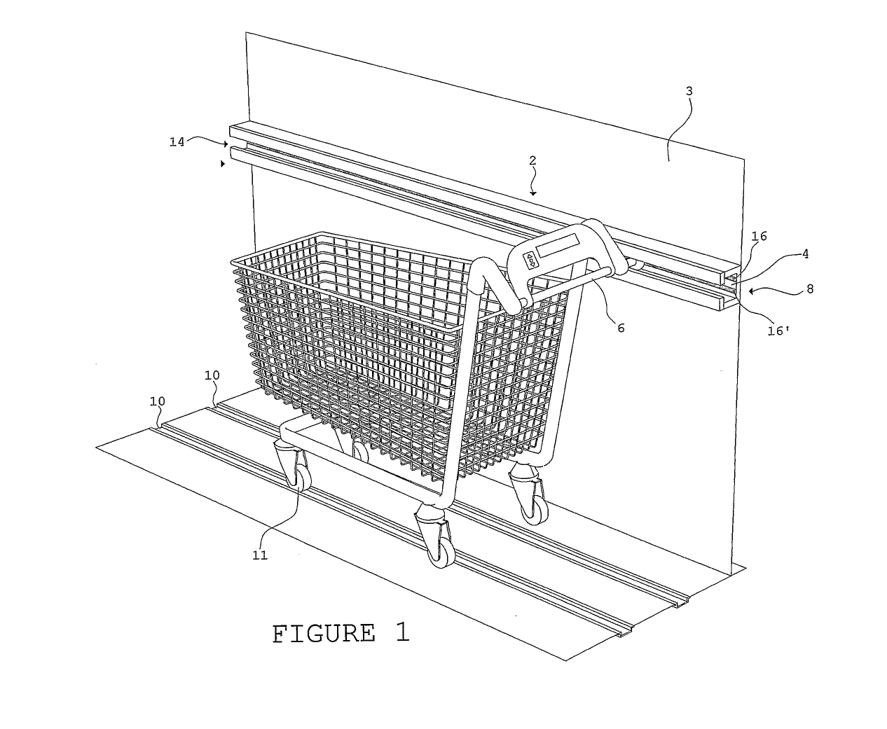

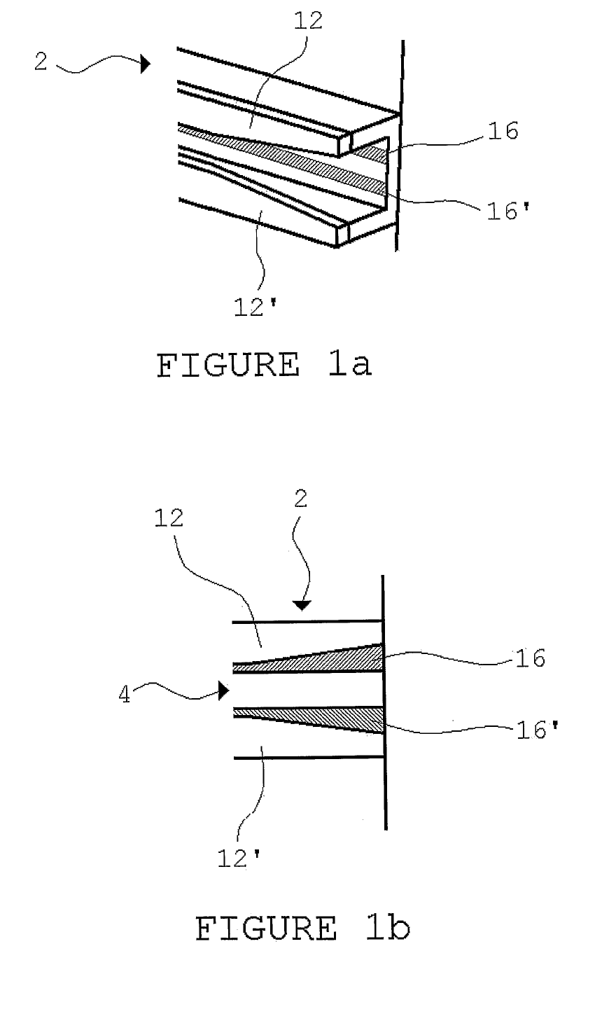

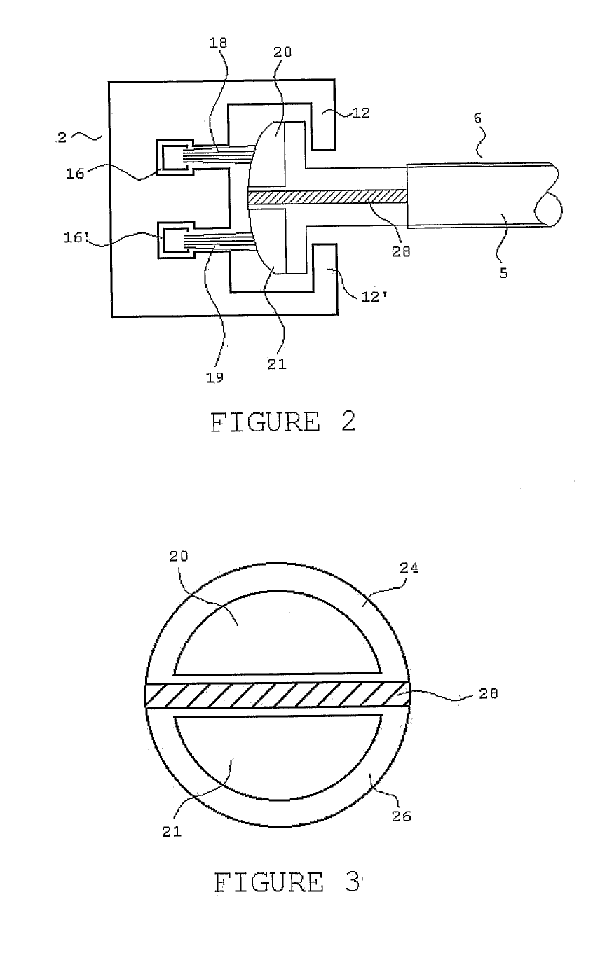

In one embodiment, as illustrated in FIG. 1, there is provided guide rail 2 mounted onto wall 3. Guide rail 2 is provided with a channel 4 through which a trolley handle 6 may pass. Trolley handle 6 acts as a protrusion to be inserted into entry end 8 of guide rail 2. Trolley handle 6 can be moved along channel 4, with guideways 10 provided in the floor aligning front wheels 11, thus ensuring correct alignment of trolley handle 6 in channel 4 (i.e. maintaining a constant separation of trolley handle 6 in relation to channel 4). Flanges 12 and 12′ prevent the removal of trolley handle 6 from channel 4 before it reaches the exit end 14 of guide rail 2. Because guide rail 2 is open ended at both ends 14 and 8, if a plurality of trolleys are charged simultaneously, the trolley which has been charging for the longest period of time may be removed first.

Recesses 16 and 16′ which are provided within guide rail 2 contain two parallel phosphor bronze brush strips 18 and 19 which protrude from recesses 16 and 16′ to brush against contact areas 20 and 21 of trolley handle 6. Recesses 16 and 16′ run the length of guide rail 2 to allow trolley handle 6 to be in constant contact with the brush strips 18 and 19.

Trolley handle 6, which preferably contains battery 5, is split into upper section 24 and lower section 26. Brush strip 18 interacts with first contact area 20 on upper section 24 of trolley handle 6, and brush strip 19 interacts with second contact area 21 on lower section 26 of trolley handle 6. Upper section 24 and lower section 26 of trolley handle 6 are separated by a strip of insulating material 28.

FIG. 1 is shown with guide rail 2 and guideways 10 necessarily curtailed. Preferably, guide rail 2 is sufficiently long to allow a number of trolleys to be charged simultaneously. As one fully charged trolley leaves guide rail 2 at exit end 14, another trolley can be inserted into entry end 8 to begin charging.

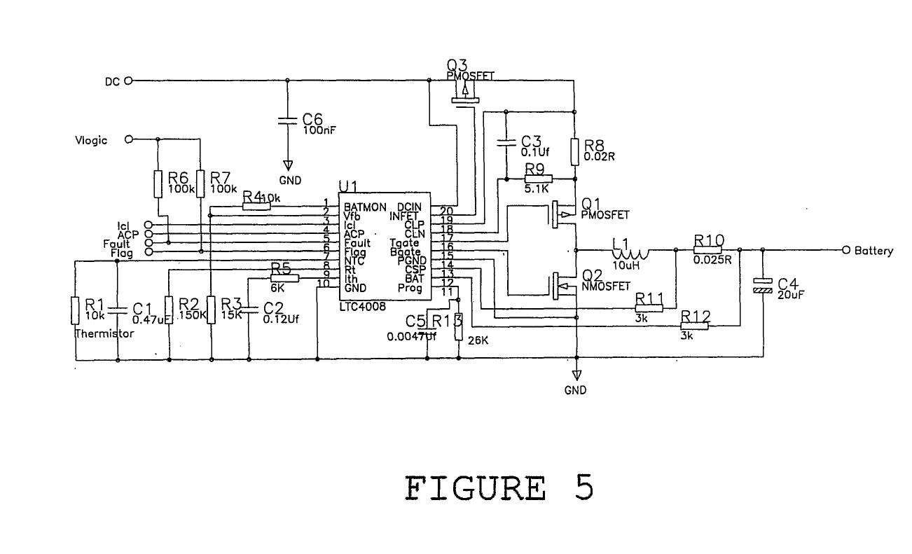

Power may be supplied to brush strips 18 and 19 via a transformer (not shown), the battery being charged via contact areas 20 and on trolley handle 6. Appropriate circuitry, such as that represented in FIG. 5, may be contained within trolley handle 6 to allow pulse charging, whereby charging is achieved by cycles of driving a constant current into the battery followed by a brief rest period, thus allowing the chemical reaction within the battery to settle and enable the battery to be charged more uniformly than it would be, for example, under constant current charging.

The circuit of FIG. 5 provides constant monitoring of the battery voltage, and gradually steps down the supply current as the voltage peaks, effectively acting as a cut-off to prevent the battery from overcharging. A thermistor is provided to monitor temperature, to allow a safety cut-off by cutting the supply current to zero if the battery overheats.

An advantage of the present invention is that because the guide rail and channel are open ended, a ‘first in first out’ system is ensured, i.e. the next trolley ready for exit from the charging station will have been charging for the longest.

A further advantage of an embodiment of the present invention is the battery can be charged without removing it from the trolley. As the battery does not have to be removed, it can be contained within the handle, thereby saving space.

A further advantage of an embodiment of the present invention is that pulse charging ensures fast charging of the trolleys, and minimises the potential for long-term damage to the battery.

Another advantage of an embodiment of the present invention is that the guideways provided in the floor ensure that the trolley handle maintains a constant separation from the brush strips in the channel. This will reduce wear of the brush strips caused by the trolley pushing into the strips, therefore the strips are not likely to become splayed and reduce the effectiveness of the charging.

Guide rail 2 is preferably formed of polyethylene due to the high insulation properties of the material. The low coefficient of friction of polyethylene will also allow trolley handle 6 to pass more easily along channel 4.

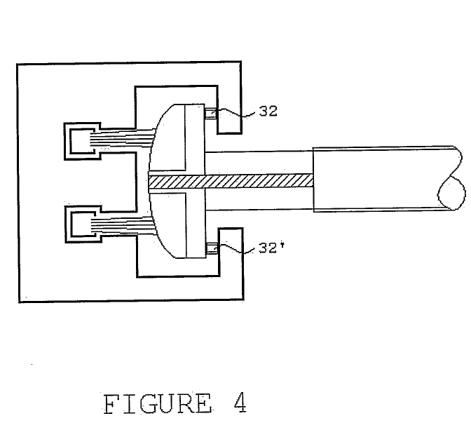

In an alternative embodiment, as illustrated in FIG. 4, guide wheels 32 and 32′ may be provided, either on the areas of trolley handle 6 adjacent to the flanges 12 and 12′, or the flanges 12 and 12′, to aid the movement of the trolley handle along channel 4.

As illustrated in FIGS. 1a and 1b, flanges 12 and 12′ could be tapered towards entry end 8 of guide rail 12, so as to aid the insertion of the trolley handle into channel 4 by acting as a guide.

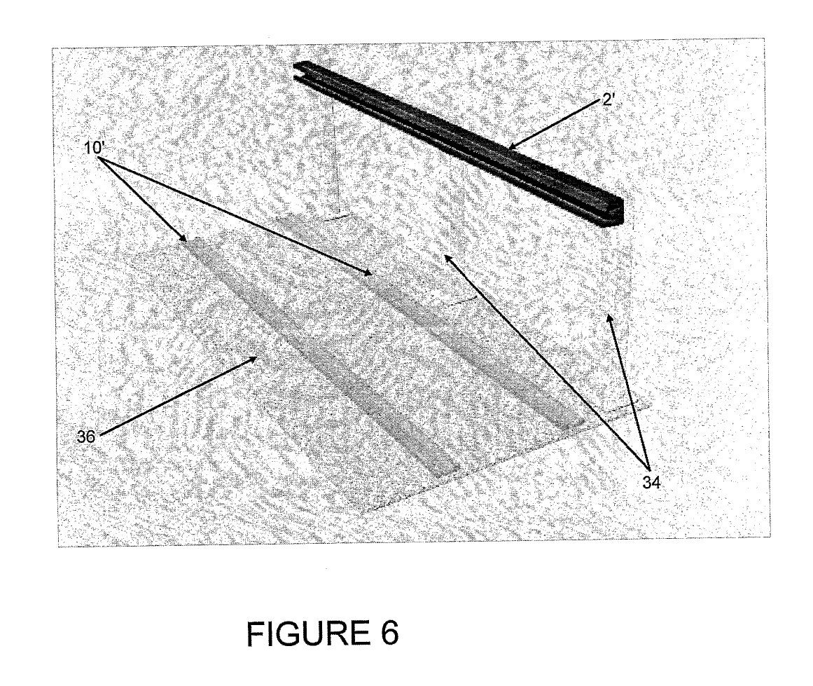

In a further alternative embodiment, as illustrated in FIG. 6, a free-standing charging station could be provided, wherein guide rail 2′ is attached to one or more upright support posts 34, to allow greater flexibility in the situation of the charging station and for ease of shop fitting. The integral module illustrated in FIG. 6 which may be provided for example in a 2 m length, is be conveniently relocatable. Guide rail 2′ may be vertically adjustable to different trolley heights, and tracks 10 may be movable in relation to an aluminium or steel baseplate 36 to allow for different trolley wheel gauges.

Brush strip contacts 18 and 19 could alternatively be sprung metal strips, and could be formed of an alternative material such as copper. An alternative charging method could also be used.

Whilst the invention is primarily designed for battery operated equipment provided on a trolley, such as a supermarket trolley, the term “trolley” is intended to include any form of mobile equipment, or equipment arranged to have mobile provision. For example, a supermarket shopping basket with a display unit could be recharged using a similar arrangement to that shown in FIG. 1 but where the basket is moved on a conveyor belt adjacent the channel.

1. An arrangement for charging a battery provided on a trolley, the arrangement comprising a channel with linear contacts and, on a part of the trolley insertable into the channel, contacts arranged to interact electrically with the linear contacts, the arrangement characterised in that the channel is open at both ends and at least two of the trolley contacts are each connected to different poles of the battery.

2. An arrangement as claimed in claim 1 wherein the linear contacts include phosphor bronze brush strips.

3. An arrangement as claimed in claim 1 wherein the linear contacts are housed within recesses provided in the channel.

4. An arrangement as claimed in claim 1 wherein the part of the trolley comprises a handle.

5. An arrangement as claimed in claim 4 wherein the battery is contained within the handle.

6. An arrangement as claimed in claim 1 wherein means are provided to maintain a constant separation of the trolley part relative to the channel.

7. An arrangement as claimed in claim 6 wherein the means to maintain a constant separation of the trolley part relative to the channel consists of flanges provided on the channel and floor-mounted guideways.

8. An arrangement as claimed in claim 1 wherein means are provided to guide the trolley part into the channel.

9. An arrangement as claimed in claim 1 wherein the contact areas are separated by a strip of insulating material.

10. An arrangement as claimed in claim 1 arranged to receive a plurality of trolleys.

11. An arrangement as claimed in claim 1 wherein charging is by pulse charging.

12. An arrangement as claimed in claim 1 wherein means are provided to prevent the overcharging of the battery.

13. An arrangement as claimed in claim 1 wherein the channel is formed of polyethylene.

14. An arrangement as claimed in claim 1 wherein guide wheels are provided between the trolley part and the channel.

15. An arrangement as claimed in claim 1 wherein the contacts include sprung copper strips.

16. (canceled)
